(19) United States
(12) Patent Application Publication
(10) Pub. No.: US 2013/0137324 A1
(43) Pub. Date: May 30, 2013

(54) CARBON NANOTUBE COATINGS FOR VISIBLE AND IR CAMOUFLAGE

(71) Applicant: Xiaowu Shirley Tang, Waterloo (CA)

(72) Inventor: Xiaowu Shirley Tang, Waterloo (CA)

(21) Appl. No.: 13/637,119

(22) PCT Filed: Mar. 25, 2011
(86) PCT No.: PCT/CA2011/000309

§ 371 Date: Nov. 26, 2012

Related U.S. Application Data
(60) Provisional application No. 61/282,748, filed on Mar. 25, 2010.

(51) Int. Cl. C09D 5/32; C09D 5/00

(52) U.S. Cl. CPC C09D 5/32; C09D 5/006; Y10S 977/742; Y10S 977/752; Y10S 977/75; B82Y 40/00
USPC 442/131; 427/600; 428/221; 977/742; 977/752; 977/750

(57) ABSTRACT

The present invention provides carbon nanotube coated fabric compositions for the purpose tuning the optical properties of fabric, in particular the optical transmittance, absorption, and reflectance in the visible, NIR and mid-IR ranges. The carbon nanotube coated fabrics of the present invention exhibit relatively uniform absorptivity and reflectivity of light across visible and IR spectral ranges and are ideal for use in stealth operations for counteracting night vision detection devices. The carbon nanotube coatings are thin, flexible coatings exhibiting high thermal and chemical stability, strong adhesion, low weight, and high tensile strength. In one embodiment, the composition includes an insulator layer for thermally isolating the CNT coating and establishing thermal equilibrium with the surrounding environment through the absorption of thermal IR emitted from hot objects. Processes for preparing the carbon nanotube coated fabrics are also described herein.

This application claims priority from U.S. Provisional Patent Application No. 61/282,748 filed Mar. 25, 2010.

### TECHNICAL FIELD

The present invention relates to carbon nanotube compositions and in particular to carbon nanotube coated fabrics and processes for preparing same.

### BACKGROUND OF THE INVENTION

Optical detection techniques are employed in military and surveillance operations for detecting targets of interest in low light and zero illumination settings. In general, there are three types of night vision detection devices: Type I devices (or image intensification devices) amplify visible light reflected from objects in low lighting conditions; Type II devices are equipped with an infrared (IR) source for detecting reflected IR from objects in the dark; and Type III devices detect thermal IR emitted from objects, such as heat generated by the human body.

Significant research has been undertaken with a view to developing materials for counteracting the detection mechanisms described above. In order to avoid detection in the visible light range (380-750 nm) or near-IR (NIR) to low mid-IR range (750 nm-2.5 μm), such materials must possess high optical absorptive and low reflective (or anti-reflective) properties within these respective ranges. Within the mid-IR range (2.5-14 μm), camouflage against “heat seekers” or other thermal IR targeting systems requires absorption or containment of thermal mid-IR reflections and matching the optical emission of the target to its surroundings in the mid-IR range. Notably, all objects emit mid-IR (or black body IR) in accordance with their standing temperature and, in particular, humans emit a standing IR between 7-14 μm. Traditional anti-thermal coatings, designed to counteract Type III devices, comprise metal and/or metal compounds, which are highly reflective and therefore susceptible to Type I and Type II detection.

Properties of carbon nanotubes (CNTs), as a class of materials, are especially interesting because of their uniquely advantageous characteristics, including high electrical conductivity, high mechanical strength and wide spectral absorption in the ultraviolet (UV), visible and NIR ranges (estimated from 200 nm to 200 μm). Optical spectroscopy techniques such as absorption, photoluminescence and Raman spectroscopy of CNT have been used in identifying CNT, determining CNT quantity in various media, and investigating CNT molecular and electronic structures. More recently, optical properties of CNT thin films, especially transparency in the visible-NIR range have been reported due to the increased interest in the applications of such thin films in flexible, transparent and opto-electronics.

In this regard, U.S. patent application Ser. No. 11/157,206 to Bamdad describes a device for harnessing nanotube chains for electronic systems, in the form of a two-layered device comprising an arrangement of nanoparticles positioned to interact with an electromagnetic field for preferentially transmitting a first wavelength of incident radiation relative to a second wavelength thereof. In addition, U.S. Pat. No. 7,898,079 to Lashmore describes the use of carbon nanotubes for thermal management of electronic components in the form of a heat conducting medium for facilitating the transfer of heat from a heat source to a heat sink comprising a flexible membrane made from an array of interweaving carbon nanotubes. A method of manufacturing the heat-conducting medium is also provided.

U.S. Pat. No. 7,354,877 to Rosenberger discloses a carbon nanotube woven material, an in particular, a multilayered fabric comprised of a series of individual woven fabric layers including a layer comprising carbon nanotube fibers and yarns interwoven with one another. The fabric of Rosenberger is touted for its mechanical, thermal, electrical, physical and chemical properties, associated with the carbon nanotube fibers. Further, U.S. patent application Ser. No. 11/273,894 to Frankel describes a carbon allotrope composition in the form of a modified synthetic polymer filament and multifilament yarn of low IR reflectance comprising a polymer and a quantity of carbon black (another carbon allotrope). Other embodiments describe processes for making yarns, including fully drawn and partially oriented yarns. The polymer filaments and yarns of Frankel can be used to form fabrics in accordance with standard textile processing means, including weaving and knitting.

### SUMMARY OF THE INVENTION

In one aspect, the present invention is directed to a novel CNT coated fabric composition for the purpose tuning the optical properties of the fabric, in particular the optical transmittance, absorption, and reflectance in the visible, NIR and mid-IR ranges. As opposed to traditional stealth coating materials, including NIR absorbers such as carbon black, the absorptive CNT coated fabric exhibits high thermal and chemical stability, strong adhesion without need for a binder, low weight, and high tensile strength.

The CNT coatings described herein are thin coatings demonstrated to effectively alter the optical signatures of the coated fabrics. Specifically, the CNT coated fabrics exhibit relatively uniform absorptivity and reflectivity across visible and IR ranges. The CNT coatings described herein can also be modified, for example by altering the density of CNTs on the outer layer of the fabric, for the purpose of matching and/or mimicking the optical reflection of surrounding objects within the mid- to far-IR range.

According to one aspect of the present invention, there is provided a carbon nanotube coated fabric exhibiting the optical properties of carbon nanotubes within the visible and IR ranges comprising a layer of fabric material having coated directly thereon a plurality of carbon nanotubes. The plurality of carbon nanotubes are bound in secure engagement with the outer layer of fabric material.

In another aspect of the present invention, the carbon nanotube coated fabric includes an at least one inner layer comprising a suitable insulator, such as neoprene. In this embodiment, the coated carbon nanotube fabric is capable of isolating thermal IR from a hot object, while the outer CNT coated layer effectively absorbs emitted mid-IR light. In yet another aspect of the present invention, processes are provided for the preparation of a CNT coated fabric composition exhibiting the optical properties of carbon nanotubes within the visible and IR ranges, characterized by the steps of suspending CNTs in a solvent solution, sonicating the suspended CNTs to produce a uniform CNT suspension, and coating fabric with the uniform CNT suspension for a set length of coating time to produce a CNT coated fabric of a given carbon nanotube density. Coating of the CNT suspension onto the fabric promotes binding of the CNT to the fabric. The length of coating time is directly proportional to the CNT density of the CNT coated fabric. Also provided are compositions prepared in accordance with the processes of the present invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

A detailed description of the preferred embodiments is provided below by way of example only and with reference to the following drawings, in which:

FIG. 1 shows a block diagram illustrating a scale-up process for the continuous preparation of a CNT suspension in accordance with the present invention.

FIG. 2 shows the IR absorption of CNT using Fourier Transform Infrared Spectroscopy.

FIG. 3(a) illustrates a SEM image of cotton fabric coated with the CNT suspension of the present invention at 2000× magnification.

FIG. 3(b) illustrates a SEM image of cotton fabric coated with the CNT suspension of the present invention at 100000× magnification.

FIG. 4(a) shows the transmissivity of polyester fabrics coated with the CNT suspension of the present invention at a density of (i) 0.17 mg/cm²; and (ii) 0.06 mg/cm², and uncoated.

FIG. 4(b) shows the reflectivity of polyester fabrics coated with the CNT suspension of the present invention at a density of (i) 0.17 mg/cm²; and (ii) 0.06 mg/cm², and uncoated.

FIG. 4(c) shows the absorptivity of polyester fabrics coated with the CNT suspension of the present invention at a density of (i) 0.17 mg/cm²; and (ii) 0.06 mg/cm², and uncoated.

FIG. 5 depicts a representative drawing of a layered structure in accordance with one aspect of the present invention, consisting of an insulating layer and a CNT coated layer.

FIG. 6 shows: (i) a photo of a prototype product coated with the CNT suspension of the present invention; (ii) an IR image of an uncoated prototype product; and (iii) an IR image of the coated prototype product of (i).

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

As described herein, CNT coatings for use on fabric materials (such as polyester and cotton) are demonstrated to effectively alter the optical signatures of the coated fabrics. Specifically, CNT coated fabrics exhibit relatively uniform absorptivity and reflectivity across the visible, NIR, and mid-IR ranges. At low tube densities, on the order of 0.1 mg/cm² or less, the CNT coating is anti-reflective and absorptive, while at high tube densities, above the critical density where a highly conductive network of CNTs is formed on fabrics, the CNT coating behaves similarly to thin metal films and becomes reflective in the mid-IR and far-IR ranges. Taken together, the CNT coatings described herein offer the possibility to construct fabrics with consistently high absorptivity and tunable reflectivity over a broad spectral range.

In various embodiments of the present invention there are provided processes for the preparation of homogeneous and stable CNT suspensions essential to produce a uniform and thin coating on fabrics through liquid-deposition methods, wherein the CNTs are uniformly distributed on the fabric without compromising fabric flexibility. In accordance with the present invention, suitable liquids for preparing CNT suspensions may be organic or aqueous in nature and may include combinations of organic solvents and aqueous solutions.

While suspension of various types of carbon nanotubes are useful according the processes described herein, the present invention optionally utilizes single-walled carbon nanotubes (SWNT) and multi-walled carbon nanotubes (MWNT). In a preferred embodiment, the carbon nanotubes are SWNTs or small diameter MWNTs. SWNTs and MWNTs can be formed by a variety of conventional methods already known in the art.

In one embodiment of the present invention, a plurality of CNTs are directly sonicated in solvent to produce a CNT suspension. Use of an organic solvent which produces a stable and uniform CNT suspension is desired. While suitable organic solvents may include isopropanol, methanol, ethanol, ethylene glycol (EG), dichloromethane (DCM) and chloroform, in a preferred embodiment DCM is the organic solvent and SWNT is suspended in DCM in a concentration range of 0.1 mg/ml to 10 mg/ml. In an alternative embodiment, the CNT suspension is produced on sonicating CNT in aqueous solution, for example, de-ionized water and a suitable surfactant, such as SDBS, SDS or TX-100. In a preferred implementation, CNT is suspended in aqueous solution at a concentration of 10 mg/ml.

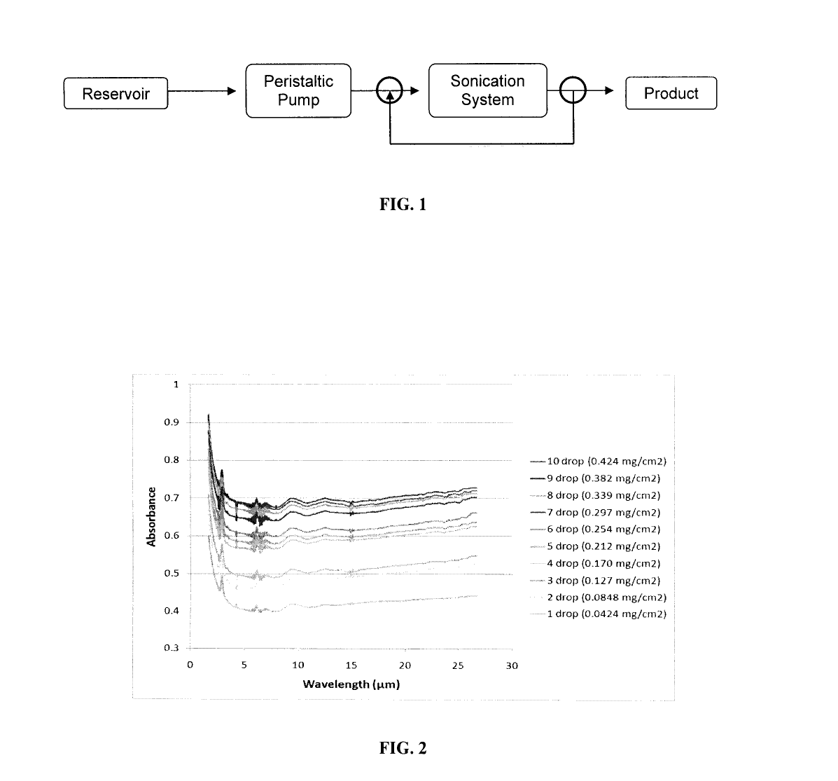

Referring now to FIG. 1, a scale-up process is depicted for the continuous preparation of CNT suspensions and deposition of the CNT coating onto products, such as fabrics. In the design flow, a plurality of CNTs are added into a reservoir with either an organic solvent or an aqueous solution of surfactant. The reservoir is continuously agitated to produce a coarse suspension of CNTs with large aggregates. The coarse CNT suspension is then pumped into a sonication system. A peristaltic pump may be utilized at this step. In one aspect of the present invention, the sonication system consists of small channels immersed in a bath sonicator. Each sonication channel may embody a plurality of glass coils for the purpose of increasing the path of the suspension and thus increasing the duration of sonication. An outlet from the sonication system is to a drop dispenser for the coating stage. As indicated by the encircled pathway points in FIG. 1, switches may optionally be installed at both the inlet and outlet of the sonication channel for the purposes of controlling the number of sonication rounds to be applied prior to dispensing the CNT suspension.

Several methods may be utilized for coating (or liquid deposition of) the resultant CNT suspension onto fabric materials, including drop-casting, dipping, spin coating, rod coating, and spray coating. Coating of the CNT suspension onto the fabric promotes binding of the CNTs to at least the outer surface of the fabric. The chemistry underlying formation of the bond between the CNTs and the fabric is set out below. In one example, CNTs bind to fabrics through hydrogen bonds, Van der Waals, and hydrophobic interactions. In another example, a low percentage of hydroxyl (—OH) and/or carboxyl groups (—COOH) formed on the CNTs (by defects introduced during synthesis and/or purification of the CNTs or by pre-treating the CNTs in acid) are converted to CNT-amines. Many fabrics, including cotton and polyester, contain abundant functional hydroxyl groups which can be activated to react with the amines on the CNTs to create covalent linkages between the CNTs and the fabric. Optionally, a polymer binder could be added to the CNT suspension to promote further cross-linking between the CNTs and the fabric.

Owing to the fast evaporation of certain organic solvents, such as DCM, drop-casting, spray coating, and spin coating are the preferred deposit methods where CNT is suspended with these organic solvents. In one such method, the SWNT-DCM suspension is drop-casted onto fabric and the resultant fabric is dried to remove the solvent. In this implementation, the SWNT-DCM coated fabric was dried at 70° C. for 1-2 hours to fully remove DCM.

Where aqueous solutions of CNT are used, the fabric may optionally be dip coated by soaking the fabric in the appropriate CNT suspension. The CNT suspension may be stirred in order to promote contact of the suspension with the fabric and consequent binding of the CNTs to the fabric. The time required to complete the fabric coating step will vary depending on the fabric composition and desired CNT density.

In particular implementations of the present invention, coating times ranged from one to six hours, and washing and drying cycles were applied to all CNT coated fabrics to remove excess loosely bonded CNTs. The end result is a CNT coated fabric wherein the CNTs are bound to the fabric coated on the outer layer in a substantially evenly distributed array.

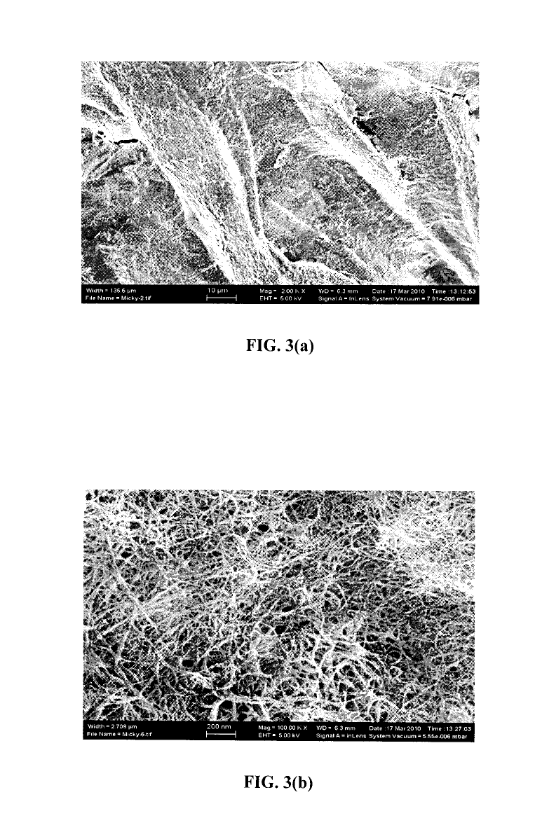

FIG. 2 illustrates the optical absorption of CNT in the IR range obtained using transmission Fourier Transform Infrared (FTIR) Spectroscopy. In this method, CNT-DCM at a concentration of 0.3 mg/ml was drop casted onto a KBr pellet. A background spectrum was obtained using a clean KBr pellet with no CNT-DCM sample, in order to correct reflection loss. An FTIR spectrum was acquired after each addition of a CNT-DCM drop (from one drop to ten drops) and a set of FTIR spectra were obtained. The results on FTIR Spectroscopy indicate that CNT absorbs strongly over a broad range of the electromagnetic spectrum, from visible (380-750 nm), near IR (750-2500 nm), to mid-IR (2.5 um-25 um). The addition of each CNT-DCM drop increased CNT density on the KBr pellet by approximately 0.0424 mg/cm² and IR absorption was observed to increase consistently with CNT density. The positive correlation between IR absorption and CNT density can serve as a useful guide to a user tasked with determining the CNT density on a fabric required to attain a desired absorbency within the spectrum range.

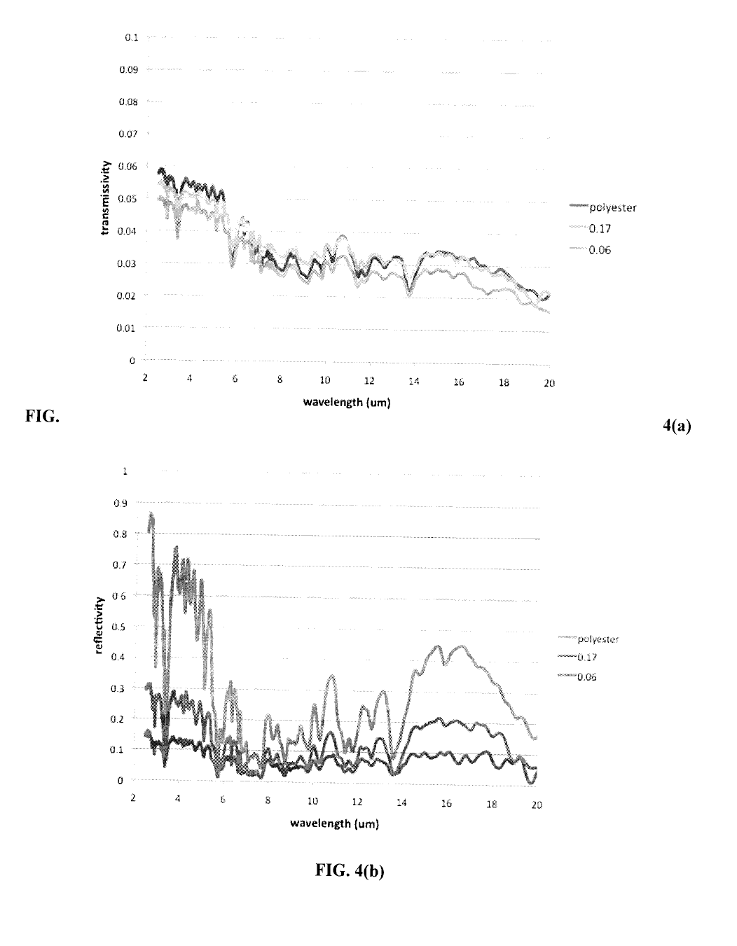

Referring next to FIGS. 3(a) and (b), scanning electron microscope (SEM) images of cotton coated with the CNT coating of the present invention are shown at 2000× and 100,000× magnification, respectively. SEM was performed to ensure full and uniform distribution of CNTs on a surface of the fabric. In these images, an SWNT-DCM suspension was spin coated onto 100% cotton at approximately 0.424 mg/cm². The large pillar structures shown at 2000× magnification are the cotton fibers, whereas a layer of web-like CNTs can be observed at 100,000× magnification.

Several tests were performed on CNT coated cotton fabrics to investigate its sustainability and longevity. The CNT coating used for these tests was prepared by drop casting SWNT-DCM onto 100% cotton to achieve a final CNT density of 0.424 mg/cm². The SWNT coated cotton was first placed in an industry acceptable heat cycle, stimulating extreme temperatures ranging from 75° C. to −30° C. The sample was heated in a convection oven at 75° C. for about 5 hours, left at room temperature for 1 hour, and placed into a freezer at −30° C. for 5 hours. This cycle was repeated three times, with the duration at 75° C. increased to 14 hours in the second iteration. Following the heat cycle, no obvious difference was observed on the CNT coated fabric.

To investigate the strength of the carbon nanotube coating in a wet environment, a water bath test was conducted. The CNT coated cotton was immersed in a water bath and agitated for 48 hours. No visible amount of CNT washed off. Next, sandpaper with grits of 80, 100, 150, and 220 were applied to different sections of the sample. No observable CNTs rubbed away from the fabric itself and no observable carbon nanotubes were deposited on the sandpaper itself. IR transmittance and reflectance spectra of the CNT coated cotton before and after the water bath and sandpaper tests showed no apparent difference either. This particular sample was left in the ambient environment for over a year. The coated fabric remained intact and showed no sign of degradation under visual and FTIR inspection, indicating strong binding between the CNT materials and the cotton fiber matrix of the fabric.

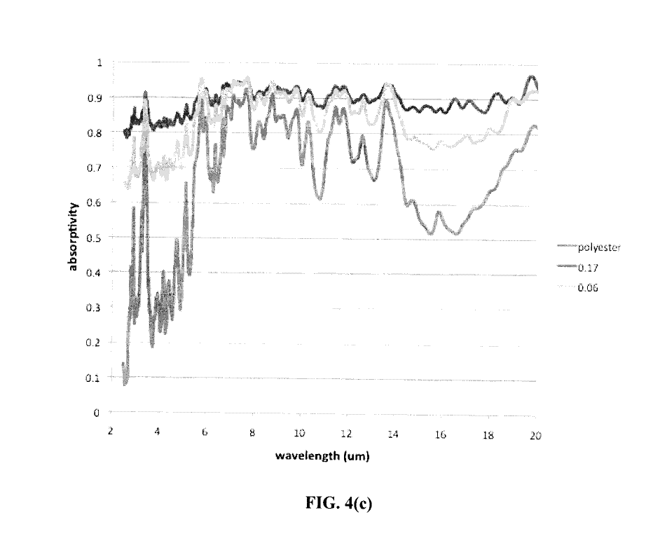

Optical transmissivity, reflectivity, and absorptivity of CNT coated fabrics in the mid-IR range (2.5 μm-20 μm) were measured using reflectance FTIR. FIGS. 4(a) to (c), respectively, show the transmissivity, reflectivity, and absorptivity results from a reference polyester fabric (without CNT coating) and polyester samples with SWNT coating at densities of 0.17 mg/cm² and 0.06 mg/cm² respectively. Absorptivity is calculated from the measured reflectivity and transmissivity. While all three fabric samples showed low transmittance of mid-IR light (2% to 6%), the reflectivity of SWNT coated polyester fabrics was shown to be significantly lower than the uncoated reference sample. Also, SWNT coated polyester showed higher and relatively even absorptivity over the entire mid-IR range, while lower reflectivity and higher absorptivity was observed at higher SWNT densities. Applied to polyester fabrics, the SWNT coating altered the IR signature, where the high reflectivity and low absorptivity windows between 2-6 μm and 14-20 μm became much less pronounced.

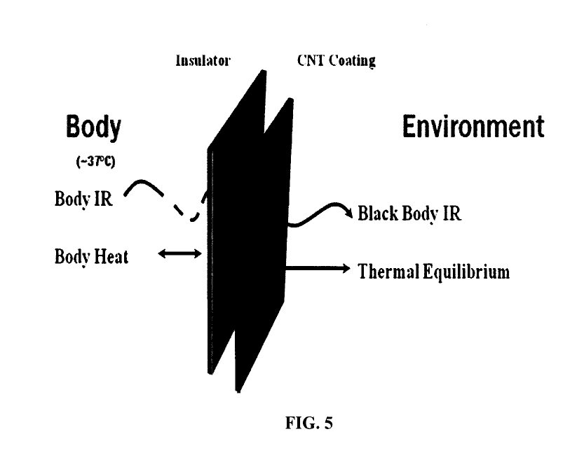

As previously discussed, there are three general categories of night vision detection devices. Type I devices amplify visible light reflected from objects at low lighting conditions. Type II devices are equipped with an IR source that detects reflected IR from objects in dark. Type III devices detect thermal IR emitted from objects, such as a body heat. One embodiment of the present invention includes a composition for counteracting all three detection methods described above. In this regard, FIG. 5 shows a schematic diagram of a layered structure with CNT coating which can render invisibility to “heat seekers” (Type III devices). It is contemplated that the layered structure can consist of one or more inner layers of insulators and CNT coatings. Each insulator layer thermally isolates the CNT coating from hot objects (e.g. human body), while the outer CNT coating effectively absorbs mid-IR light emitted from hot objects. Owing to the high thermal conductivity and low mass of the CNT coating, fast thermal equilibrium with the surrounding environment is readily achieved, and the black body IR radiation emitted from the CNT coating itself has the IR characteristics of the surrounding environment. The CNT coating itself is anti-reflective in both the visible and IR ranges and has a wide absorption spectrum (0.2 to 200 m). In the case of anti-type I & II detection, no insulator layer is necessary.

In one aspect of the present invention, a layered CNT composition for absorbing light in each of the visible, NIR, and mid-IR ranges is prepared by applying the CNT coating to an outer layer of a fabric and adding an at least one inner layer of thermal insulating material. In an example embodiment, the CNT coating on the fabric of an object (including but not limited to wearable materials) was prepared by drop-casting SWNT-DCM (5 mg/ml) directly onto the outer layer of the product, the outer layer comprised of 100% cotton, and mixing the components until a surface nanotube density on the outer layer of approximately 0.45 mg/cm² was achieved. In this example, 2 mm thick neoprene was selected as the material for the inner insulating layer for the purpose of shielding body heat from the external environment.

Using an infrared thermometer, the body temperature of a human participant was recorded at 30.0° C., while the temperature of the layered CNT composition was recorded at 23.6° C. Therefore, substantial thermal equilibrium of the outer layer of the CNT composition (the CNT coated fabric) with the environment was established with sufficient isolation of body heat.

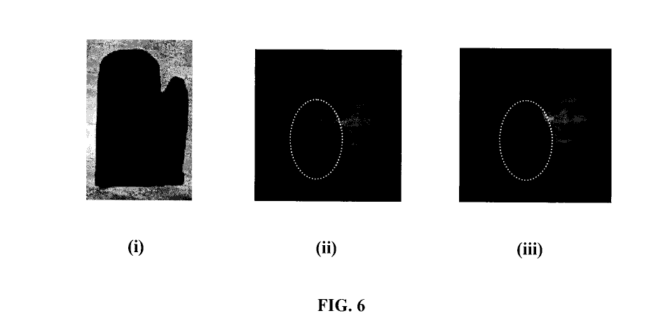

Next, to test the effectiveness of the layered CNT composition of the present invention, the CNT coated external layer of the prototype product, shown in FIG. 6(i), was tested against an uncoated compare product using a night vision device (e.g. NewconOptik™ Phantom 20, Generation I). In general, the night vision device operates by illuminating IR radiation and detecting reflected IR from objects. The test was performed in outdoor conditions under minimal visible light. As shown in FIG. 6(ii), the external surface of the uncoated product and a human face are clearly visualized through the night vision device. Meanwhile, in FIG. 6(iii), the CNT coated external layer of the prototype product of the present invention is shown blended in to its dark surrounding environment.

While the tests described above contain data obtained from the use of SWNT coatings, coatings formed by small MWNT (<8 nm in diameter) were shown to perform very similarly to SWNT, although mass densities of MWNT on fabrics have to be adjusted to account for the difference in molecular weight.

What is claimed is:

1. A carbon nanotube coated fabric exhibiting the optical properties of carbon nanotubes within the visible and IR ranges characterized by:
an outer layer of fabric material; and
a plurality of carbon nanotubes, the plurality of carbon nanotubes coated directly on the outer layer of fabric material and bound in secure engagement with the outer layer of fabric material.

2. The carbon nanotube coated fabric of claim 1 further characterized by:
an at least one inner layer, wherein each of the at least one inner layers is characterized by a thermal insulator.

3. The carbon nanotube coated fabric of claim 2 wherein the thermal insulator is neoprene.

4. The carbon nanotube coated fabric of claim 1 wherein the plurality of carbon nanotubes are a plurality of single-walled carbon nanotubes.

5. The carbon nanotube coated fabric of claim 1 wherein the plurality of carbon nanotubes are coated on the outer layer in an array of substantially even distribution.

6. The carbon nanotube coated fabric of claim 1 wherein the carbon nanotube coated fabric is flexible.

7. A process for preparing a carbon nanotube coated fabric exhibiting the optical properties of carbon nanotubes within the visible and IR ranges, characterized by the steps of:
suspending carbon nanotubes in a solvent solution;
sonicating the suspended carbon nanotubes to produce a uniform carbon nanotube suspension; and
coating fabric with the uniform carbon nanotube suspension for a set length of coating time to bind the carbon nanotubes to the fabric to produce a carbon nanotube coated fabric of a given carbon nanotube density, wherein the length of coating time is directly proportional to the carbon nanotube density of the carbon nanotube coated fabric.

8. The process of claim 7 further characterized by the step of washing the carbon nanotube coated fabric to remove excess loosely bonded carbon nanotubes.

9. The process of claim 7 further characterized by the step of drying the carbon nanotube coated fabric to remove the solvent solution.

10. The process of claim 7 wherein the carbon nanotubes are selected from the group consisting of single-walled carbon nanotubes and multi-walled carbon nanotubes.

11. The process of claim 10 wherein the carbon nanotubes are single-walled carbon nanotubes.

12. The process of claim 7 wherein the concentration of carbon nanotubes in solution is in the range of 0.1 mg/ml to 10 mg/ml.

13. The process of claim 7 wherein the solvent solution is selected from the group consisting of methanol, ethanol, ethylene glycol, dichloromethane and chloroform.

14. The process of claim 13 wherein the solvent solution is dichloromethane.

15. The process of claim 7 wherein the solvent solution is characterized by a water and surfactant solution.

16. The process of claim 7 wherein the length of time of the coating step is in the range of one to six hours.

17. The process of claim 7 wherein the coating step is characterized by drop-casting the uniform carbon nanotube suspension onto the fabric.

18. A carbon nanotube coated fabric made by the process of claim 7.

19. The carbon nanotube coated fabric of claim 18 further characterized by:
an outer layer coated with the uniform carbon nanotube suspension of claim 7; and
an at least one inner layer, wherein each of the at least one inner layers is characterized by an insulator.

20. The carbon nanotube coated fabric of claim 19 wherein the insulator is neoprene.
